(19) United States
(12) Patent Application Publication
(10) Pub. No.: US 2012/0231290 A1
(43) Pub. Date: Sep. 13, 2012

(54) METAL NANOSTRUCTURE AND PREPARATION THEREOF

(75) Inventors: Rong-Ming Ho, Hsinchu (TW); Han-Yu Hsueh, Hsinchu (TW)

(73) Assignee: National Tsing Hua University, Hsinchu (TW)

(21) Appl. No.: 13/472,711

(22) Filed: May 16, 2012

Related U.S. Application Data
(63) Continuation-in-part of application No. 13/005,637, filed on Jan. 13, 2011.
Application No. 13/005,637 is a continuation-in-part of application No. 12/655,342, filed on Dec. 29, 2009.

(30) Foreign Application Priority Data
Jul. 3, 2009 (TW) 98122686
Nov. 17, 2011 (TW) 100142089

(51) Int. Cl. B32B 3/00; C22B 5/00; B32B 15/00; B32B 3/26; B32B 3/12; B05D 5/00; B32B 5/00

(52) U.S. Cl. 428/566; 427/256; 75/330; 428/546; 428/332; 428/312.8; 428/222; 428/118; 428/336

(57) ABSTRACT

Nanoporous polystyrene matrix can be fabricated from the self-assembly of degradable block copolymer, polystyrene-b-poly(L-lactide) (PS-PLLA), followed by the hydrolysis of PLLA blocks. Metal is deposited in nanopores of the PS matrix using the nanoporous PS as a template via electroless plating. After subsequent UV degradation of the PS matrix, metal in the nanopores remains, yielding a metal nanostructure. The metal nanostructure may be a gyroid nanostructure, helical nanostructure or columnar nanastructure.

### CROSS REFERENCE TO RELATED PATENT APPLICATIONS

The present patent application claims the benefit of Taiwan Patent Application Number 98122686, filed Jul. 3, 2009; Taiwan Patent Application Number 100142089, filed Nov. 17, 2011; and U.S. patent application Ser. No. 13/005,637, filed Jan. 13, 2011, which is a continuation-in-part application of U.S. patent application Ser. No. 12/655,342, filed Dec. 29, 2009, the contents of which are hereby incorporated by reference in their entireties.

### Field of the Invention

The present invention is related to a metal nanostructure including, for examples, a self-standing block of a metal nanostructure, and a layer of a metal nanostructure formed on a surface of a substrate having an area of 0.5 cm x 0.5 cm or more. The metal nanostructure is useful in making a supercapacitor, high-power-density battery, hydrogen storage, electromagnetic composite, surface enhanced Raman spectroscopy, antimicrobial scaffold, filtration device, desalination device, heat sink, ultrahigh field electromagnet, and magnetic medium.

### BACKGROUND OF THE INVENTION

U.S. Pat. No. 7,135,523 B2 discloses a method for making a series of nanoscale microstructures, including helical microstructures and cylindrical microstructures. This method includes the steps of: (1) forming a chiral block copolymer containing a plurality of chiral first polymer blocks and second polymer blocks wherein the chiral first polymer blocks have a volume fraction ranging from 20 to 49%; (2) causing a phase separation in the chiral block copolymer. In a preferred embodiment, the chiral block copolymer is poly(styrene)-poly(L-lactide) (PS-PLLA) chiral block copolymer, and the copolymerization process is a living copolymerization process which includes the following steps: (a) mixing styrene with BPO and 4-OH-TEMPO to form 4-hydroxy-TEMPO-terminated polystyrene; and (2) mixing the 4-hydroxy-TEMPO-terminated polystyrene with [(η₃-EDBP)Li₂]₂[(η₃-“Bu)Li(0.5Et₂O)]₂ and L-lactide in an organic solvent preferably CH₂Cl₂ to form the poly(styrene)-poly(L-lactide) chiral block copolymer. Transmission electron microscopy (TEM) and small X-ray scattering (SAXS) studies show that when the volume fraction of poly(L-lactide) is about 35-37%, nanoscale helices with a pitch of 43.8 nanometers and a diameter of 34.4 nanometers were observed.

US patent publication 2004/0265548 A discloses a nanopatterned template for use in manufacturing nanoscale objects. The nanopatterned template contains a nanoporous thin film with a periodically ordered porous geomorphology which is made from a process comprising the steps of: (a) using a block copolymerization process to prepare a block copolymer comprising first and second polymer blocks, the first and second polymer blocks being incompatible with each other; (b) forming a thin film under conditions such that the first polymer blocks form into a periodically ordered topology; and (c) selectively degrading the first polymer blocks to cause the thin film to become a nanoporous material with a periodically ordered porous geomorphology. In a preferred embodiment, the block copolymer is poly(styrene)-b-poly(L-lactide) (PS-PLLA) chiral block copolymer, the first polymer is poly(L-lactide), and the second polymer is polystyrene.; Experimental results show that the first polymer blocks can be formed into a hexagonal cylindrical geomorphology with its axis perpendicular to a surface of the thin film. After hydrolysis to selectively degrade the first polymer blocks, a thin film having a series of repeated nanoscale hexagonal-cylindrical channels is obtained.

US patent publication 2006/0124467 A discloses metal nanodot arrays and fabrication methods thereof. A film of a block copolymer is deposited on a conductive substrate. The block copolymer comprises first polymer and second polymer blocks, wherein the first polymer blocks have a periodically ordered morphology. The first polymer blocks are selectively degraded to form a nanopatterned template comprising periodically ordered nanochannels. By electroplating, metal is deposited into the nanochannels that expose the conductive substrate, thus forming a metal nanodot array.

Rong-Ming Ho, et al. in an article entitled, “Helical Nanocomposites from Chiral Block Copolymer Templates”, J. AM. CHEM. SOC. 2009, 131, 1356-1357, disclose a three-dimensional ordered helical nanocomposite prepared with the combination of the self-assembly of a degradable block copolymer and sol-gel chemistry. PS with helical nanochannels is prepared first from the self-assembly of the PS-PLLA chiral block copolymer after hydrolysis, and then used as template. By exploiting the nanoreactor concept, sol-gel reaction is then carried out within the template so as to fabricate a helical nanocomposite. SiO₂ nanohelices can be obtained after degradation of PS template under UV exposure.

US patent publication 2011/0003069 A discloses a fabrication method of a nanomaterial by using a polymeric nanoporous template. First, a block copolymer bulk is made from a block copolymer polymerized from decomposable and undecomposable monomers. By removing the decomposable portion of the block copolymer bulk, the polymeric nanoporous template with a plurality of holes is obtained, and these holes have nanostructures with regular arrangement. By exploiting a nanoreactor concept, a sol-gel process or an electrochemical synthesis, for example, is then carried out within the template such that the holes are filled with various filler materials, such as ceramics, metals and polymers, so as to prepare a nanocomposite material having the nanostructure. After removing the polymeric nanoporous template, the nanomaterial with the nanostructure is manufactured.

The inventors of the present application in an article, entitled “Inorganic Gyroid with Exceptionally Low Refractive Index from Block Copolymer Templating”, Nano Lett. 2010, 10, 4944-5000, published on Internet on Nov. 3, 2010, and in US patent publication US 2011/0104401 A disclose an antireflection structure of SiO₂ gyroid having an exceptional low refractive index, e.g. as low as 1.1, prepared by first forming a layer of PS-PLLA chiral block copolymer with spin coating and solvent annealing, followed by the hydrolysis, sol-gel process, and degradation of PS template described above.

Details of the disclosures in the aforesaid US patent and patent publication, and the aforesaid articles are incorporated herein by reference.

### SUMMARY OF THE INVENTION

The invention of the present application provides a metal nanostructure, wherein said metal can be nickel, gold, silver or copper, and preferably nickel.

The invention of the present application provides a self-standing centimeter scale metal nanostructure, which can be a gyroid nanostruture or interconnected helical nanostructure. In one of the preferred embodiments of the present invention a self-standing gyroid nanostruture of nickel.

The invention of the present application provides a layer of a metal nanostructure with a large area on a surface of a substrate, wherein said layer has a continuous area of 0.5 cm×0.5 cm or greater and said metal is nickel, gold, silver or copper, and preferably nickel

Preferably, the metal nanostructure of the layer is a porous gyroid nanostructure, a series of periodically ordered helical nanostructure or a series of periodically ordered hexiganol columnar nanostructure, and more preferably a porous gyroid nanostructure.

Preferably, the layer has a thickness of about 100 nm to about 200 nm.

The invention of the present application provides a device comprising a metal nanostructure, wherein said device is selected from the group consisting of a supercapacitor, high-power-density battery, hydrogen storage, electromagnetic composite, surface enhanced Raman spectroscopy, antimicrobial scaffold, filtration device, desalination device, heat sink, ultrahigh field electromagnet, and magnetic medium; said metal is nickel, gold, silver or copper; said metal nanostructure is A) a self-standing centimeter scale gyroid nanostructure or interconnected helical nanostructure, or B) a layer of a porous gyroid nanostructure, a series of periodically ordered helical nanostructure or a series of periodically ordered hexiganol columnar nanostructure on a surface of a substrate, wherein said layer has a continuous area of 0.25 cm² or greater than 0.25 cm².

A suitable substrate for use in the invention of the present application includes (but not limited to) quartz, glass, polymer and semiconductor. The layer of the metal nanostructure can be formed directly on the surface of the substrate without an electrically conductive layer being formed thereon in advance. That is the surface of the substrate is not electrically conductive. This is accomplished through an improved electroless plating technique disclosed in the invention of the present application. Preferably, the semiconductor is a silicon wafer or silicon oxide substrate. Alternatively, the glass substrate can be a indium tin oxide (ITO) deposited glass substrate or a carbon-coated glass substrate.

A process for preparing a metal nanostructure according to the invention of the present application comprises the following steps:
a) providing a nanoporous template;
b) impregnating the nanoporous template in a solution containing palladium ions;
c) removing the nanoporous template from the solution and rinsing the nanoporous template with a rinsing liquid;
d) impregnating the rinsed nanoporous template in an electroless plating bath, so that the palladium ions remained in the nanoporous template are reduced to palladium atoms, then metal ions contained in the electroless plating bath are reduced to an elemental metal in the presence of the palladium atoms as a catalyst, and thus nanopores of the nanoporous template are filled with the elemental metal to obtain a composite, wherein the elemental metal is nickel, gold, silver or copper.

Preferably, the process further comprises: e) removing the nanoporous template from the composite resulted from step d) by using an ultraviolet light exposure, calcination, organic solvent, a supercritical fluid or a combination thereof to obtain a metal nanostructure of nickel, gold, silver or copper.

The nanoporous template in step a) can be a self-standing nanoporous template having gyroid nanochannels, or a series of periodically ordered helical nanochannels, and preferably gyroid nanochannels. This self-standing nanoporous template is used to form a self-standing metal nanostructure from step e), i.e. a metal nanostructure block.

Alternatively, the nanoporous template in step a) can be a layer formed on a surface of a substrate, and the nanoporous template has gyroid nanochannels, a series of periodically ordered helical nanochannels or a series of periodically ordered hexagonal-cylindrical nanochannels, and preferably gyroid nanochannels. Accordingly, the resultant product from step e) of the preparation process of the present invention is a substrate with a layer of a metal nanostructure having a large area on a surface thereof; and the resultant product from step d) of the preparation process of the present invention is a substrate with a composite layer of a nanoporous template filled with a metal having a large area on a surface thereof.

The preparation process of the present invention is unique, because the nanopores in the nanoporous template are easy to be blocked during the electroless plating, and thus the formation of a metal nanostructure fails. For examples, stannous chloride used in the sensitizing step of the conventional electroless plating process will form colloids to block the nanopores in the nanoporous template, and elemental metal reduced from electroless plating bath may agglomerate to block the nanopores in the nanoporous template when the distribution of palladium catalyst in the nanopores is too dense, so that the Is electroless plating bath cannot enter the nanopores smoothly, and thus jeopardizes the continuation of the electroless plating.

Another characteristic of the invention of the present application is the metal deposited by the conventional electroless plating is amorphous, and is subjected to, for example, a high temperature sintering in order to be converted to crystalline metal with better mechanical properties; on the contrary, the metal nanostructure prepared by the process of the present invention is crystalline. By taking advantage of the self-catalytic behavior of electroless plating for an automatically continuous process of elemental metal formation, the reduced elemental metal may serve as the new nucleus for the following reduction of metal ions so that the elemental metal deposition process could continue until the nanochannels were fully filled. We speculate that the rate of reduction works together with the self-ordering (i.e., crystallization) process of elemental metal so as to result in the formation of high crystallinity metal in the preparation process of the present invention.

Preferably, the solution containing palladium ions in step b) has a concentration of palladium ions of 0.06-6.0 mg/ml. In one of the preferred embodiments of the present invention, the solution containing palladium ions used in step b) has a concentration of palladium ions of 0.6 mg/ml. Preferably, the solution containing palladium ions in step b) further contains a surface tension modifier to enhance the wetting of the nanoporous template. The surface tension modifier for example is a C1-C4 alcohol. Preferably, the solution containing palladium ions in step b) further contains a solubility enhancer for enhancing a solubility of a palladium salt in the solution containing palladium ions used in step b). For example, the solubility enhancer can be an acid. In one of the preferred embodiments of the present invention, the solution containing palladium ions used in step b) was prepared by dissolving 0.05 g of PdCl₂ in a mixture of 45 ml of ethanol and 5 ml of 1 N HCl aqueous solution.

Preferably, the rinsing liquid used in step c) can be any liquids suitable for washing off Pd⁺² from the outer surfaces of the nanoporous template, for examples deionized water, alcohol, ether, ester or a mixture thereof. In one of the preferred embodiments of the present invention, the rinsing liquid used in step c) was a mixture of ethanol and water.

Preferably, the electroless plating bath in step d) contains a reducing agent for reducing palladium ions to palladium atoms. A suitable reducing agent includes (but not limited to) hydrazine, hydrazine hydroxide, formaldehyde, sodium borohydride, dimethylformamide, β-D-glucose, ethylene glycol, sodium citrate, ascorbic acid, dimethyl sulfoxide, potassium bitartrate, methanol, ethanol, propan-1-ol, propan-2-ol, pyridine poly(ethylene glycol), tris(trimethylsiloxy)silane and hydrogen.

Preferably, the nanoporous template used in step a) is a porous ceramic, porous metal or porous polymer. More preferably, the nanoporous template is a porous polymer selected from the group consisting of poly(styrene), poly(vinylpyridine), and poly(acrylonitrile), and most preferably, poly(styrene).

A suitable process for preparing a self-standing polymeric nanoporous template used in the invention of the present application includes the steps of providing a chiral block copolymer containing a first polymer block and second polymer block wherein the first polymer block is selected from the group consisting of poly(L-lactide) and poly(D-lactide), and the second polymer block is selected from the group consisting of poly(styrene), poly(vinylpyridine), and poly(acrylonitrile); adjusting a volume fraction of the first polymer block in the chiral block polymer to cause the first polymer block form gyroid nanostructure or a series of periodically ordered helical nanostructure in the second polymer block; and selectively degrading the first polymer block to form gyroid nanochannels or a series of periodically ordered helical nanochannels therein. In a preferred embodiment, the chiral block copolymer is poly(styrene)-poly(L-lactide) (PS-PLLA) chiral block copolymer.

A suitable process for preparing a layer of polymeric nanoporous template formed on a surface of a substrate used in the invention of the present application includes the steps of: coating a layer of an organic solvent solution of a block copolymer having first polymer block and second polymer block on a substrate modified with an organic material, wherein said first polymer is selected from the group consisting of poly(L-lactide), poly(D-lactide), poly(lactide), and poly(acprolactone), and said second polymer is selected from the group consisting of poly(styrene), poly(vinylpyridine), and poly(acrylonitrile); solvent annealing the resultant coating layer by placing the coated substrate in an atmosphere containing a vapor of nonpreferential solvent so as to form a film of the block copolymer having the second polymer block as a matrix thereof and the first polymer block having a nanostructure in the matrix; selectively degrading said first polymer block to form correspondingly nanochannels in the matrix of said film. The formed nanochannels are gyroid nanochannels, a series of periodically ordered helical nanochannels or a series of periodically ordered hexagonal-cylindrical nanochannels, and preferably gyroid nanochannels. Preferably, the coating is spin coating. Preferably, the organic solvent solution has a concentration of said block copolymer ranging from 1.5-10 wt %, and more preferably about 3 wt %. The organic solvent is dichlorobenzene, chlorobenzene, dichloromethane, toluene, tetrahydrofuran and so on, and more preferably, dichlorobenzene. Preferably, the coating layer has a thickness of about 100 nm to about 200 nm.

Preferably, the organic material used to modify the substrate is hydroxyl terminated polystyrene, hydroxyl terminated poly(vinylpyridine), or hydroxyl terminated poly(acrylonitrile), and more preferably hydroxyl terminated polystyrene. Preferably, the hydroxyl terminated polystyrene has a molecular weight of 5000-10000.

Preferably, said block copolymer is poly(styrene)-poly(L-lactide) (PS-PLLA) chiral block copolymer, said first polymer block is poly(L-lactide), and said second polymer block is polystyrene. Preferably, the volume fraction of the first polymer block such as PLLA in said block copolymer such as PS-PLLA is 36-50%, and more preferably about 40%.

Preferably, the first polymer block is selectively degraded by hydrolysis.

Preferably, the second polymer block matrix is removed by using an organic solvent, for examples tetrahydrofuran (THF) or toluene.

Preferably, the second polymer block matrix is removed by using a ultraviolet light exposure, for example a wavelength of 254 nm and an intensity of 3 mW/cm².

### BRIEF DESCRIPTION OF THE DRAWINGS

FIG. 1a shows a transmission electron microscopy (TEM) image of the microsection of solution-cast PS-PLLA sample with specific thermal treatment prepared in Example of the present invention.

FIG. 1b presents the [111] projected image of the PS/Ni gyroid nanohybrids without staining prepared in Example of the present invention.

FIG. 2a shows a 3D image of the gyroidforming Ni nanostructure in the PS matrix reconstructed from a set of 2D images at different tilt angles for projection in Example of the present invention.

FIG. 2b displays the field emission SEM (FESEM) microscopy image of the nanoporous gyroid Ni in the PS/Ni gyroid nanohybrids after removal of the PS templates in Example of the present invention.

FIG. 2c shows the X-ray diffraction (XRD) profile of the nanoporous gyroid Ni in Example of the present invention.

FIG. 3 shows a low-magnification FESEM imaging of the nanoporous gyroid Ni in Example of the present invention, wherein the inset show the photograph of centimeter-sized nanoporous gyroid Ni bulks.

FIG. 4 displays the elected area electron diffraction (SAED) pattern of the Ni gyroid nanostructure in the nanohybrids taken from FIG. 1b, wherein the diffraction rings are indexed with the face-centered cubic (fcc) Ni polycrystals.

### DETAILED DESCRIPTION OF THE INVENTION

The poly(styrene)-poly(L-lactide) (PS-PLLA) chiral block copolymer and method of preparing the same has been disclosed in U.S. Pat. No. 7,135,523 B2, which forms nanoscale microstructures, including helical microstructures and cylindrical microstructures depending on the volume fraction of PLLA. US patent publication 2004/0265548 A discloses a nanopatterned template for use in manufacturing nanoscale objects, wherein a spin-coated PS-PLLA layer on a substrate is subjected to hydrolysis so that PLLA is removed to form a periodically ordered nanoporous topplogy. Rong-Ming Ho, et al. in an article entitled, “Helical Nanocomposites from Chiral Block Copolymer Templates”, J. AM. CHEM. SOC. 2009, 131, 1356-1357, further use the nanoscale microstructure of OS-PLLA disclosed in U.S. Pat. No. 7,135,523 B2 to prepare a three-dimensional ordered helical nanocomposite with the incorporation of the sol-gel chemistry, so as to fabricate SiO₂ nanohelices. The inventors of the present application in US patent publication US 2011/0104401 A discloses an antireflection structure with an exceptional low refractive index, e.g. as low as 1.1, wherein nanoporous polymers with gyroid nanochannels are fabricated from the self-assembly of degradable block copolymer, polystyrene-b-poly(L-lactide) (PS-PLLA), followed by the hydrolysis of PLLA blocks. A well-defined nanohybrid material with SiO₂ gyroid nanostructure in a PS matrix is obtained using the nanoporous PS as a template for the sol-gel reaction. After subsequent UV degradation of the PS matrix, a highly porous inorganic gyroid network remains, yielding a single-component material with an exceptionally low refractive index (as low as 1.1).

The inventors of the present application use the chiral block copolymer disclosed in the aforesaid patent applications and articles to form nanoreactors with nanoporous channels of various geomorphologies; and develop a novel improved electroless plating technique to successfully form metal nanostructures in the nanoporous channels of the nanoreactors. The improved electroless plating technique developed by the inventors of the present application skips the sensitizing step required by the conventional electroless plating processes (impregnating in a stannous chloride aqueous solution), and combines activation step (generation of catalytic sites—palladium clusters) and electroless plating step (reduction of metal ions) in one solution. Pd clusters are generated within the nanopores of the nanoreactors, which are activation sites for the metal ions in the electroless plating bath to be reduced on said sites thereafter. By taking advantage of the self-catalytic behavior of electroless plating for an automatically continuous process of metal formation, the reduced metal may serve as the new nucleus for the following metal reduction so that the metal deposition process could continue until the nanochannels were fully filled. Polymer/metal nanohybrids are thus obtained. In one of the preferred embodiments of the present invention a templated Ni gyroid nanostructure in the polymer matrix was directly observed via a 3D tomography of transmission electron microscopy (TEM). The Ni gyroid nanostructure was recovered from the polymer matrix and kept intact after the polymer template being removed with a suitable solvent. A 3D metallic network of high porosity (up to 62%) was thus obtained. Unlike the conventional nanoporous metallic structure, the 3D metallic network prepared in accordance with the present invention has a well ordered nanostructure. Further, the inventors of the present application can easily prepare well constructed polymer/metal nanohybrids of different compositions such as gold, silver, and copper, etc., which should have a great potential to be applied in the fields related to metamaterials, green energy and chemical catalysis.

The following examples via experimental procedures are illustrative and are intended to demonstrate embodiments of the present invention, which, however, should not be taken to limit the embodiments of the invention to the specific embodiments, but are for explanation and understanding only, since numerous modifications and variations will be apparent to those skilled persons in this art.

### EXAMPLES

### Abbreviation:

L-LA: L-lactide

PS: polystyrene

PLLA: poly(L-lactide)

PS-PLLA BCP: poly(styrene)-poly(L-lactide) chiral block copolymer

PDI: polydispersity

BCP: block copolymer

### Synthesis of PS-PLLA BCP

The PS-PLLA BCP was prepared by a double-headed polymerization sequence. We described the synthesis of the PS-PLLA sample previously [Ho, R. M.; Chen, C. K.; Chiang, Y. W.; Ko, B. T.; Lin, C. C. Adv. Mater. 2006, 18, 2355-2358]. The number-average molecular weight and the molecular weight distribution (polydispersity) of the PS were determined by GPC. The polydispersity of PS-PLLA was determined by GPC and the number of L-LA repeating units was determined as a function of the number of styrene repeating units by ¹H NMR analysis. The number-average molecular weights of PS and

PLLA, and the PDI of PS-PLLA are 34000 g mol⁻¹, 27000 g mol⁻¹ and 1.26, respectively. The volume fraction of PLLA is thus calculated to be f_{PLL}A^{v}=0.39, by assuming that densities of PS and PLLA are 1.02 and 1.248 g cm⁻³, respectively.

### Sample Preparation

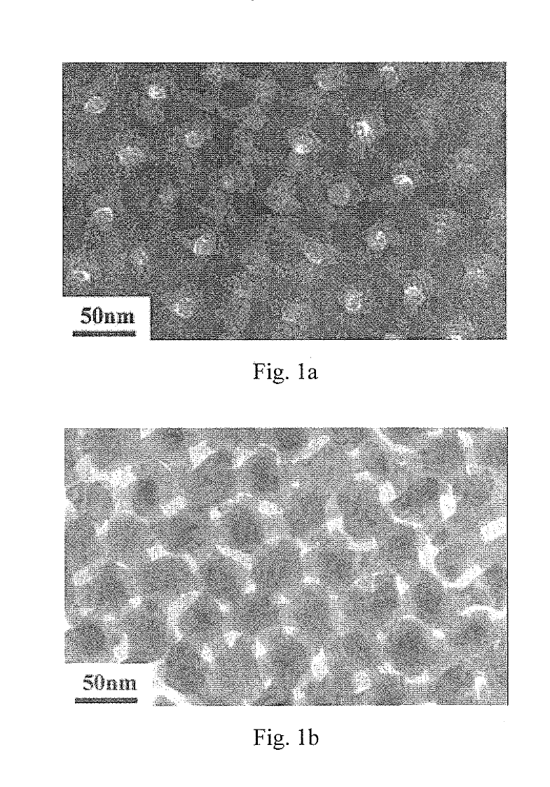

Bulk samples of PS-PLLA BCP were prepared by solution casting from dichloromethane (CH₂Cl₂) solution (10 wt % of PS-PLLA with PLLA volume fraction, fPLLA v=0.39) at room temperature for two weeks and then dried in a vacuum oven at 65° C. for three days. The dry samples were first heated to the maximum annealing temperature, Truax=175° C. for three minutes to eliminate the PLLA crystalline residues that were formed during the preparation procedure. They were finally quenched to room temperature. After quenching from the microphase-separated ordered melt at 175° C., the thermally treated block copolymers were sectioned using an ultra-microtome for TEM observation. The result is shown in FIG. 1a.

### Hydrolysis of PLLA

Then, the PLLA blocks of the PS-PLLA bulk samples were removed by hydrolysis, using a 0.5M basic solution that was prepared by dissolving 2 g of sodium hydroxide in a 40/60 (by volume) solution of methanol/water. After three days of hydrolysis, the hydrolyzed samples were rinsed using a mixture of deionized (DI) water and methanol, and then used as templates for the following modified electroloess plating process.

### Modified Electroless Plating Process

The nanoporous PS templates with interconnected tortuous air network were soaked in an activating solution formed by mixing ethanol (45 mL), HCl (1N, 5 mL), and PdCl₂ (0.05 g) with stirring at room temperature for several hours (3˜4 hrs). After washing gently with ethanol/H₂O solution to remove redundant Pd⁺² covering on sample surfaces, the pore-filled samples were immersed into a freshly prepared Ni bath at room temperature. In the Ni bath, 0.2 g of nickel chloride (NiCl₂.6H₂O) was dissolved in a solution consisting of distilled water (20 mL), ethanol (5 mL), hydrazinium hydroxide (85%, 2 mL), and ammonia (2 mL). Consequently, the nucleation of Pd clusters would be initialized at which Pd⁺² ions can be reduced to Pd clusters by hydrazinium hydroxide. Note that the concentration of activating solution prepared here was quite low, and redundant Pd⁺² covering on sample surface was washed out. As a result, only a small amount of Pd clusters can be generated within the PS templates. Accordingly, Ni⁺² were reduced to Ni arising from the catalytic sites of the Pd clusters. Because the electroless plating of Ni is an automatic, continuous process, Ni would be generated continuously from the interior of PS template until the nanochannels are completely filled with Ni. Consequently, well-ordered Ni networks dispersed in PS matrix were prepared.

### Removal of PS Template

To produce the nanoporous gyroid Ni, the PS matrix of the PS/Ni gyroid nanohybrids was removed by waching with tetrahydrofuran (THF). The process was carried out by stirring at room temperature under atmosphere conditions for 24 h. Consequently, the nanoporous gyroid Ni with a well ordered nanostructure was easily obtained.

### Results

FIG. 1a shows the transmission electron microscopy (TEM) image of the microsection of solution-cast PS-PLLA sample with specific thermal treatment as described. The PS matrix, selectively stained with RuO₄, appears dark whereas the PLLA microdomains appear bright. The [100] projected image of the PS-PLLA suggests the formation of a gyroid phase. Corresponding 1D small angle X-ray scattering (1D SAXS) profiles (not shown in the drawings) further confirm the observed gyroid phase. The interdomain spacing of (211)_{gyroid} was determined to be approximately 40.9 nm from the primary reflection. After hydrolysis in a mild aqueous base, the PLLA blocks of the PS-PLLA could be removed completely, and the 1D SAXS profile (not shown in the drawings) of the PS-PLLA after hydrolysis remain unchanged. The interdomain spacing of (211)_{gyroid} of the PS template was determined to be approximately 39.8 nm from the primary reflection, indicating that there was a 2.6% shrinkage of its original size. The porosity and interfacial area per gram of the nanoporous PS template were approximately 37% and 97 m² g⁻¹ as determined by nitrogen adsorption experiments and Brunauer-Emmett-Teller analyzer (BET) analysis, respectively.

FIG. 1b presents the [111] projected image of the PS/Ni gyroid nanohybrids without staining. The projected image in FIG. 1b is similar to FIG. 1a but the contrast is reversed, suggesting that the PLLA blocks should be completely removed after hydrolysis and the formation of Ni can be successfully synthesized in the nanoporous PS templates via the modified electroless plating process.

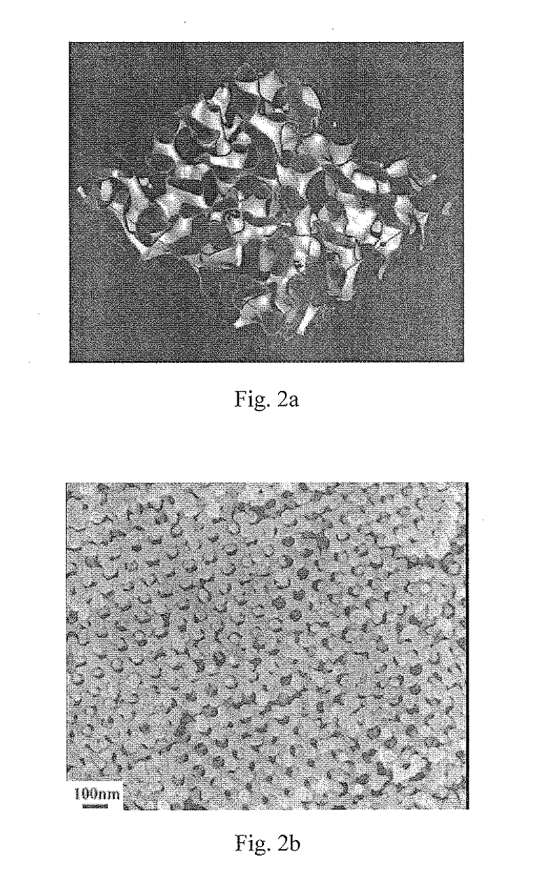

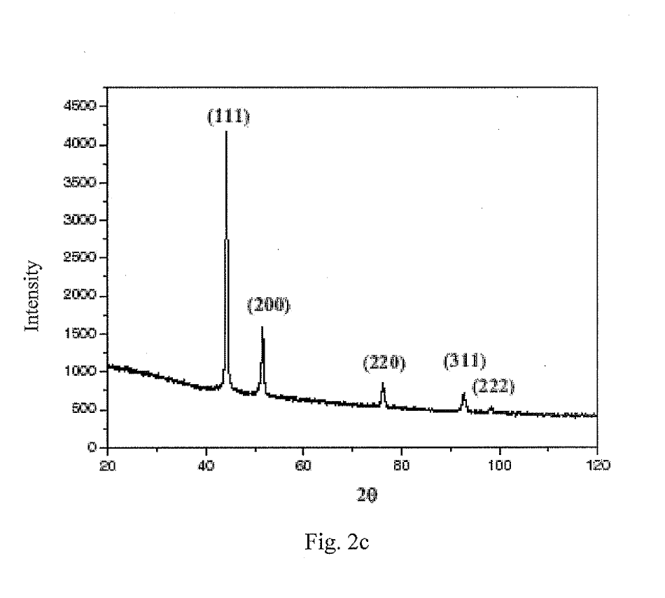

Furthermore, a 3D image of the gyroidforming Ni nanostructure in the PS matrix can be reconstructed from a set of 2D images at different tilt angles for projection (FIG. 2a). As shown in FIG. 2a, a double gyroid Ni with bicontinuous networks in a PS matrix can be directly visualized. From the 1D SAXS profile for the PS/Ni gyroid nanohybrids (not shown in the drawings), the gyroid-forming nano structure of PS/Ni nanohybrids can be identified macroscopically. The interdomain spacing of 39.8 nm ((211)_{gyroid})) is the same as the nanoporous PS templates, indicating that the gyroid morphology can be retained after the templating process. FIG. 2b displays the field emission SEM (FESEM) microscopy image of the nanoporous gyroid Ni in the PS/Ni gyroid nanohybrids after removal of the PS templates. Low-magnification FESEM imaging of the nanoporous gyroid Ni was also conducted, and the results (FIG. 3) indicate that large-area continuous materials with precisely controlled pore geometries can be well prepared. Also, the inset of FIG. 3 shows a photograph of the nanoporous gyroid Ni bulk, demonstrating the fabrication of a centimeter-sized crack-free sample. Fourier transform infrared (FT-IR) spectroscopy experiments (not shown) were conducted to further confirm that the PS can be completely removed.

The porosity of the nanoporous gyroid Ni was about 62% from nitrogen adsorption experiments, and the interfacial area per gram of the nanoporous gyroid Ni was calculated as 1467 m² mol⁻¹ (25 m² g⁻¹). The intrinsic density of pure Ni without pores via the modified electroless plating was about 8.0 g cm⁻³. As a result, the density of nanoporous gyroid Ni was about 3.05 g cm⁻³ (38% relative density).

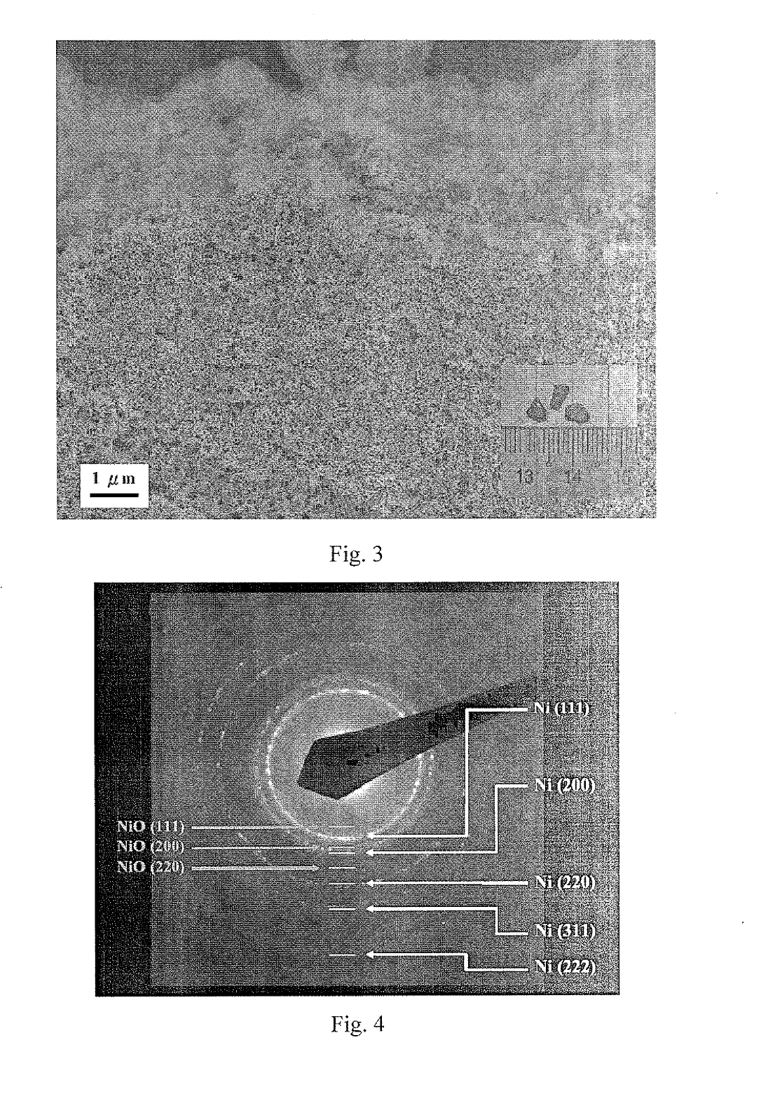

To examine crystalline character of the nanoporous gyroid Ni, selected area electron diffraction (SAED) and X-ray diffraction (XRD) experiments were conducted. FIG. 4 displays the SAED pattern of the Ni gyroid nanostructure in the nanohybrids taken from FIG. 1b, and the diffraction rings are indexed with the face-centered cubic (fcc) Ni polycrystals. In addition to the reflections from the high crystallinity Ni, the reflections resulting from the NiO crystallites marked can be identified. We thus speculate that the NiO is generated from the oxidation of Ni exposed to air and moisture. The XRD results of the nanoporous gyroid Ni shown in FIG. 2c agree with the SAED results. All the diffractions can be indexed as fcc Ni with the lattice constant α=3.540 Å, JCPDS card no. 4-856, corresponding to (111), (200), (220), (311), and (222), respectively. No characteristic peaks of impurities, such as NiO and Ni(OH)₂, could be detected. Both the SAED and XRD results demonstrate that well-defined crystalline character of Ni phase could be obtained under ambient conditions.

To the best of our knowledge, this is the first time well-defined, free-standing metallic nanoporous materials (MNMs) with high porosity and surface area have been obtained using such a straightforward method. It is apparent that the same techniques can be applied to prepare a large area layer of PS/gyroid Ni nanohybrid on a surface of a substrate, when the nanoporous template is formed on the surface of the substrate, and then to prepare a large area layer of gyroid Ni nanostructure on the surface of the substrate by removing the PS matrix. The surface of the substrate no need to be electrically conductive, because the modified electroless plating process in accordance with the present invention does not require to apply an electric current. That is a pre-deposition of a conductive layer is not necessary for the formation of the large area layer of the PS/gyroid Ni nanohybrid or gyroid Ni nanostructure on the surface of the substrate. Further, the modified electroless plating process in accordance with the present invention is very comprehensive because there are many available recipes for the deposition of various metals by using electroless plating.

1. A metal nanostructure comprising a self-standing centimeter scale gyroid nanostructure or interconnected helical nanostructure of nickel, gold, silver or copper.

2. The metal nanostructure of claim 1, wherein the metal is nickel.

3. The metal nanostructure of claim 1 which is a porous gyroid nanostructure.

4. The metal nanostructure of claim 1, wherein the metal is crystalline.

5. A layer of a metal nanostructure on a surface of a substrate, wherein said layer has a continuous area of 0.25 cm² or greater than 0.25 cm² and said metal is nickel, gold, silver or copper.

6. The layer of claim 5, wherein the metal is nickel.

7. The layer of claim 5, wherein the metal nanostructure is a porous gyroid nanostructure.

8. The layer of claim 5, wherein the metal is crystalline.

9. The layer of claim 5, wherein the metal nanostructure is a series of periodically ordered helical nanostructure.

10. The layer of claim 5, wherein the metal nanostructure is a series of periodically ordered hexiganol columnar nanostructure.

11. The layer of claim 5, which has a thickness of about 100 nm to about 200 nm.

12. The layer of claim 5, wherein the substrate is quartz, glass, polymer or semiconductor.

13. The layer of claim 5, wherein the surface of the substrate is not electrically conductive.

14. A device comprising a metal nanostructure, wherein said device is selected from the group consisting of a supercapacitor, high-power-density battery, hydrogen storage, electromagnetic composite, surface enhanced Raman spectroscopy, antimicrobial scaffold, filtration device, desalination device, heat sink, ultrahigh field electromagnet, and magnetic medium; said metal is nickel, gold, silver or copper; said metal nanostructure is A) a self-standing centimeter scale gyroid nanostructure or interconnected helical nanostructure, or B) a layer of a porous gyroid nanostructure, a series of periodically ordered helical nanostructure or a series of periodically ordered hexiganol columnar nanostructure on a surface of a substrate, wherein said layer has a continuous area of 0.25 cm² or greater than 0.25 ².

15. A process for preparing a metal nanostructure comprising the following steps:
a) providing a nanoporous template;
b) impregnating the nanoporous template in a solution containing palladium ions;
c) removing the nanoporous template from the solution and rinsing the nanoporous template with a rinsing liquid;
d) impregnating the rinsed nanoporous template in an electroless plating bath, so that the palladium ions remained in the nanoporous template are reduced to palladium atoms, then metal ions contained in the electroless plating bath are reduced to an elemental metal in the presence of the palladium atoms as a catalyst, and thus nanopores of the nanoporous template are filled with the elemental metal to obtain a composite, wherein the elemental metal is nickel, gold, silver or copper.

16. The process of claim 15 further comprising: e) removing the nanoporbus template from the composite resulted from step d) by using an ultraviolet light exposure, calcination, organic solvent, a supercritical fluid or a combination thereof to obtain a metal nanostructure of nickel, gold, silver or copper.

17. The process of claim 15, wherein the nanoporous template in step a) is a self-standing nanoporous template having gyroid nanochannels, or a series of periodically ordered helical nanochannels.

18. The process of claim 15, wherein the nanoporous template in step a) is a layer formed on a surface of a substrate, and the nanoporous template has gyroid nanochannels, a series of periodically ordered helical nanochannels or a series of periodically ordered hexagonal-cylindrical nanochannels.

19. The process of claim 17, wherein the nanoporous template in step a) has gyroid nanochannels.

20. The process of claim 18, wherein the nanoporous template in step a) has gyroid nanochannels.

21. The process of claim 15, wherein the solution containing palladium ions in step b) has a concentration of palladium ions of 0.06-6.0 mg/ml.

22. The process of claim 15, wherein the solution containing palladium ions in step b) further contains a surface tension modifier to enhance the wetting of the nanoporous template

23. The process of claim 22, wherein the surface tension modifier is a C1-C4 alcohol.

24. The process of claim 22, wherein the solution containing palladium ions in step b) further contains a solubility enhancer for enhancing a solubility of a palladium salt in the solution containing palladium ions used in step b).

25. The process of claim 24, wherein the solubility enhancer is an acid.

26. The process of claim 15, wherein the electroless plating bath in step d) contains a reducing agent for reducing palladium ions to palladium atoms.

27. The process of claim 26, wherein the reducing agent is hydrazine, hydrazine hydroxide, formaldehyde, sodium borohydride, dimethylformamide, β-D-glucose, ethylene glycol, sodium citrate, ascorbic acid, dimethyl sulfoxide, potassium bitartrate, methanol, ethanol, propan-1-ol, propan-2-ol, pyridine poly(ethylene glycol), tris(trimethylsiloxy)silane or hydrogen.
